(19) United States
(12) Patent Application Publication
(10) Pub. No.: US 2007/0169513 A1
(43) Pub. Date: Jul. 26, 2007

(54) Glass Sheet Heating Surface

(76) Inventor: Yan Zhao, Henan (CN)

Correspondence Address: GOTTLIEB RACKMAN & REISMAN PC, 270 MADISON AVENUE, 8TH FLOOR, NEW YORK, NY, 100160601, US

(21) Appl. No.: 11/569,670

(22) PCT Filed: Jun. 3, 2004
(86) PCT No.: PCT/CN04/00597

§ 371 Date: Nov. 27, 2006

(51) Int. Cl. C03B 5/24; G12B 1/00

(52) U.S. Cl. 65/162

(57) ABSTRACT

The invention discloses a glass sheet heating furnace. The furnace includes a stack, a control device and a glass sheet transfer device. The inside of the stack is divided into several heating zones. A heat accumulating type flame radiation tube is disposed in each heating zone. Diesel or natural gas or city gas or LPG is the fuel of the heat accumulating type flame radiation tube. The main fuel supplying pipes, the main wind supplying pipes and the main soot discharging pipes are disposed at the outside of the stack. A two-position four-way valve is installed in each of the heat accumulating type flame radiation tube. Two main burners of the each heat accumulating type flame radiation tube work alternately to on-off the valve. The control device controls the operation of the heat accumulating type flame radiation tube and the two-position four-way valve.

This invention discloses a type of glass sheet heating furnace, especially a furnace used to heat glass sheet through flame radiation tubes, with combustion heat as heat source, and using high-temperature exhaust gas to store heat.

### BACKGROUND OF THE INVENTION

Existing glass heating furnaces normally use electricity as energy, such as the two glass heating furnaces disclosed in Chinese patents No. ZL 02208450.9 and ZL 0228451.7. Inside each of these furnaces a lot of resistance wires, resistance tapes and electric heating elements are arranged. When it works, electric heating elements turn electric energy into heat energy and heat glass sheet with radiation or convection method. Because electricity is used as the second energy, its price is higher. At present electric power supply is insufficient, so that production is often limited by power supply. Therefore, it is in urgent to exploit and use other energies, especially cheaper energy as working energy of glass sheet heating furnace to reduce dependence on electricity energy in glass processing industry.

### SUMMARY OF THE INVENTION

Aiming to the problems in existing technology, the purpose of this invention is to provide a type of glass sheet heating furnace that heat glass sheet with radiation method by flame radiation tubes with combustion heat of fuels as working heat source, and recovering heat from high-temperature exhaust gas by a heat accumulator.

In order to reach the above goal, this invention discloses a new type of glass sheet heating furnace which includes furnace body, control devices, glass sheet inlet and outlet set on the furnace body and glass sheet transportation mechanism set in the furnace; numbers of heating zones are set inside the furnace body, at least one heat accumulation type flame radiation tube is set in each heating zone. This heat accumulation type flame radiation tube is composed of a couple of main burner guns and a radiation tube connecting the two main burner guns. The main burner gun has a heat accumulator in it and uses diesel oil, natural gas, city gas or liquefied petroleum gas as fuels. Matching with each heat accumulation type flame radiation tube, corresponding main fuel transporting pipe, main air supply pipe and main smoke venting pipe are set outside of the furnace body. Control valves are set between each main burner gun and main fuel transporting pipe. Each heat accumulation type flame radiation tube is equipt with a two-position four-way valve, the air port of the two main burner guns in the heat accumulation type flame radiation tube is connected with the main air supply pipe and the main smoke venting pipe with help of its two-position four-way valve, and burning alternately, accumulating heat alternately and venting smoke alternately through switching over by the two-position four-way valve; the control device controls each accumulation type flame radiation tube, and each two-position four-way valve.

In the preferred embodiment of the invention, the mentioned furnace body is horizontal type, including the upper furnace body and lower furnace body. In the lower furnace body is installed a roller-table type of glass sheet transportation mechanism.

In addition, the mentioned control device is a PLC programmable controller.

In addition, the mentioned radiation tube is in U shape or W shape or straight line shape, made of refractory steel.

In addition, the mentioned heat accumulator is ball type porcelain heat accumulator or honeycomb ceramic heat accumulator.

In addition, a proportion regulating valve for common use is set between the couple of main burner guns in the mentioned accumulation type flame radiation tube and the mentioned main fuel transporting pipe.

In addition an air-flow control valve is set between the mentioned two-position four-way valve and the main air supply pipe respectively. This air-flow control valve is interlinked with its corresponding proportion regulation valve.

In addition, an ignition burner gun is set in each of the mentioned main burner gun. This ignition burner gun has its own air supply pipe and fuel transportation pipe which are independent of that of the main burner gun. A control valve is set on the fuel transporting pipe. The ignition burner gun uses fuel gas as fuel.

In addition, in each of the mentioned ignition burner gun are set an electronic ignition gun and an ion type (IS) or Ultraviolet type (UV) flame detecting sensor.

In addition, in each heating zone of the mentioned furnace body, a thermocouple is set respectively to detect local temperature in each heating zone.

In addition, CO₂ gas sensors are set in the mentioned furnace body.

In addition, in the main smoke venting pipe is set a thermocouple, and a flow meter is set in the general fuel transporting pipe of each main burner gun.

This invention—a new type of glass sheet heating furnace uses heat of combustion as heat source for heating, which not only proves a completely new glass sheet heating method, but also use advanced, new-structured heat-accumulation type of flame radiation tube as heating element; and the inside of the furnace body is divided into numbers of heating zone to allocate radiation tubes; and quantity of fuel transportation of radiation tubes can be adjusted according to the temperature in each heating zone, so as to make more precise control of the temperature of heating the glass sheet inside of the furnace body and to provide reliable technical guarantee for the quality of glass sheet heating.

### BRIEF DESCRIPTION OF THE DRAWINGS

FIG. 1 is a sectional view of this invention—a new type of glass sheet heating furnace;

FIG. 2 is the top pipe laying diagram of this invention—a new type of glass sheet heating furnace.

### DETAILED DESCRIPTION OF THE INVENTION

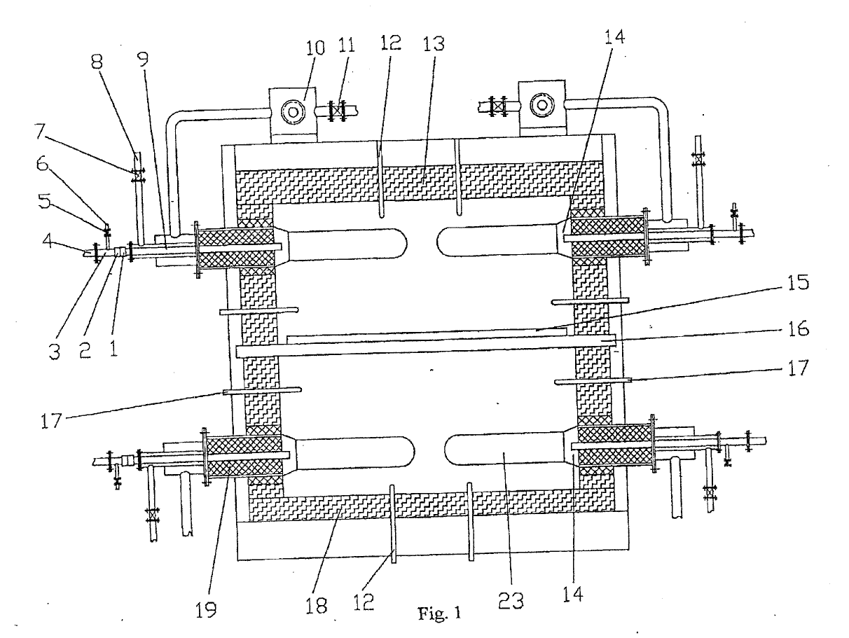

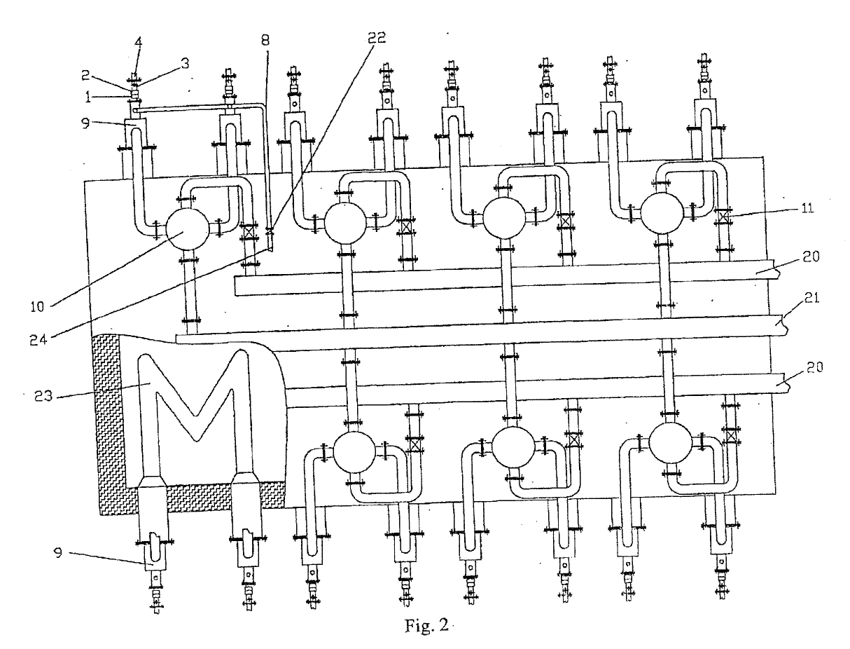

As shown in FIGS. 1 and 2, this invention—a new type of glass sheet heating furnace is in horizontal type. Said furnace body is composed of an upper furnace body 13, a lower furnace body 18. Ceramic roller-table 16 is installed on the lower furnace body 18; numbers of heating zones are set inside the upper and lower furnace bodies, one heat accumulation type flame radiation tube 14 is set in each heating zone. This heat accumulation type flame radiation tube 14 is composed of a couple of main burner guns 9 and a radiation tube 23 connecting the two main burner guns 9. Radiation tube 23 is in W shape (see FIG. 2). The two main burner guns 9 are installed with airtight at both ends of radiation tube 23. A heat accumulator 19 is set in each main burner gun 9. Said heat accumulator 19 is ball type porcelain heat accumulator or honeycomb ceramic heat accumulator. The main burner gun 9 uses diesel oil, or natural gas, or city gas or liquefied petroleum gas as fuel; Main fuel transporting pipes 24 is set outside of the furnace body (only one part of it is given in the diagram); the main air supply pipe 20 and the main smoke venting pipe 21, main fuel transporting pipes 24 are connected respectively with the fuel transporting port of each main burner gun 9 through pipe 8. Safety electromagnetic control valve 7 is set in fuel transporting pipe 8 of each main burner gun 9. Proportion regulating valve 22 for common use is set between the couple of main burner guns 9 in the accumulation type flame radiation tube 14 and the main fuel transporting pipe 24. Each heat accumulation type flame radiation tube 14 has a two-position four-way valve 10. The air port of the two main burner guns 9 in the heat accumulation type flame radiation tube 14 is connected with the main air supply pipe 20 and the main smoke venting pine 21 through the two-position four-way valve 10 that matches it. In each of the mentioned main burner gun 9 is set an ignition burner gun 3. This ignition burner gun 3 has its own air supply pipe 4 and fuel transporting pipe 6, independent of the main burner gun 9. An electromagnetic control valve 5 is set on the fuel transporting pipe 6. The ignition burner gun 3 takes natural gas, or town gas or liquefied petroleum gas as fuel. In each of ignition burner gun 3 is set an electronic ignition gun 1 and a flame detecting sensor 2. This flame detecting sensor 2 can be an ion type (IS) or Ultraviolet type (UV). In each heating zone of the upper and lower furnace bodies, a thermocouple 17 is set respectively to detect temperature in each heating zone. CO₂ gas sensors 12 are set in the upper and lower furnace bodies. An air-flow control valve 11 is set between each two-position four-way valve 10 and the main air supply pipe 20 respectively. This air-flow control valve 11 is interlinked with proportion regulation valve 22 by a connection-rod (not shown in the diagram). In the main smoke venting pipe 21 is set a thermocouple 17 (not shown in the diagram), and in the general fuel transporting pipe 24 is set a flow meter (not shown in the diagram).

After air-flow control valve 11 is connected with proportion regulation valve 22 by a connecting-rod, the quantity of fuel supply and the quantity of combustion-supporting air can be kept in a proper proportion during combustion of each main burner gun 9 so as to ensure normal work of main burner gun 9. Existing products are used for proportion regulation valve 22 and air-flow control valve 11, and both can be connected with other method for interlink.

CO₂ gas sensor 12 set in the upper and lower furnace bodies is used for detection of content of CO₂ gas inside the furnace body. In normal condition, CO₂ gas is kept in a stable concentration. When any radiation tube 23 is broken, the exhaust gas inside it leaks to the inner furnace body, at this time, concentration of CO₂ gas in the furnace body exceeds normal range. Therefore, CO₂ gas sensor 12 can be used to detect whether any radiation tube 23 is broken inside the furnace body.

Temperature detection thermocouple 17 is set in each heating zone in the upper and lower furnace bodies respectively, so that temperature distribution inside of the furnace body can be measured in real time so as to provide basis for control of the heating temperature inside the furnace body and for adjustment of temperature in each heating zone. After a flow meter is set on the main fuel transporting pipe 24, fuel consumption in the furnace can be found out in time. Thermocouple 17 is set in the main smoke venting pipe 21, so that energy saving of the furnace can be evaluated by measuring temperature of the venting smoke.

Radiation tube 23 can be in W shape or in U shape or straight, and other shapes. The radiation tubes are made of refractory steel. They are installed in the upper and lower furnace bodies.

When the furnace according to the invention is working, the control device (not shown in the diagram) composed of PLC programmable controller controls each heat accumulation type flame radiation tube and each two-position four-way valve according to the set programs.

First, electromagnetic control valve 5 works, fuel gas is sent to ignition burner gun 3 inside each main burner gun 9 though pipe 6, meanwhile, air is sent to pipe 4. Ignition gun 1 ignites ignition burner gun 3. After ignition burner gun 3 is ignited, it keeps in combustion position during the whole operation of the furnace. As soon as ignition burner gun 3 is ignited, flame detection sensor 2 send detected signals to the control device, which shows ignition burner gun 3 works normally. During the furnace is in operation, once flame detection sensor 2 has not detected flame of ignition burner gun 3, the control device will shut off electromagnetic control valve 5 and cut off fuel supply at once to ensure safety of the furnace.

After ignition burner gun 3 is ignited, two-position four-way valve 10 connects main air supply pipe 20 and a main burner gun 9 in the heat accumulation type flame radiation tube 14 at down-stream, and connects the main smoke venting pipe 21 and another main burner gun 9 in the same radiation pipe 14; at this time, the safety electromagnetic valve 7 on fuel transporting pipe 8 of the main burner gun 9 connected with main air supply pipe 20 works, fuel is sent into the main burner gun 9 and is ignited by ignition burner gun 3; flame of the main burner gun 9 after ignited enters radiation pipe 23 to heat glass sheet 15 inside the furnace body via radiation pipe 23, the exhaust gas after combustion flows to another main burner gun 9 along radiation pipe 23, and enters main smoke venting pipe 21 through the air port of main burner gun 9 and two-position four-way valve 10; after one main burner gun 9 has burned for a proper period, two-position four-way valve 10 begin to act under control of the control device to make the connection mode of the two main burner guns 9 with the main air supply pipe 20 and the main smoke venting pipe 21 switch over, the original burning main burner guns 9 stops burning and connects with main smoke venting pipe 21 using as smoke flue, the main burner guns 9 originally connecting with main smoke venting pipe 21 is switched over and connects with main air supply pipe 20, and begins to burn after it is ignited by ignition burner gun 3; circulating like this. When high-temperature exhaust gas after combustion is passing main burner guns 9 used as smoke flue, the high-temperature exhaust gas exchanges heat with heat accumulator 19 in main burner guns 9, heat accumulator 19 is heated, and exhaust gas after waste heat is absorbed vents into main smoke venting pipe 21. After heat accumulator 19 in main burner guns 9 is heated, when the main burner guns 9 turns into burning working mode, the combustion supporting air and fuel that has been sent to main burner guns 9 is pre-heated by heat accumulator 19, then begins to burn, so that the flame burning temperature is increased.

When each heat accumulation type of flame radiation tube in the upper and lower furnace bodies is working, thermocouple 17 in the furnace body detects temperature of each heating zone in real time. When temperature in a certain zone is abnormal, the control device can regulate temperature of the zone in time by adjusting quantity of fuel supply to the heat accumulation type of flame radiation tube in the zone. When the control device finds that the concentration of CO₂ gas is abnormal according to the detected result of CO₂ gas sensor 12, it will stop operation in time to ensure the safety of operators.

This invention—a new type of glass sheet heating furnace can also be made in vertical type according to the requirement. Glass sheet goes in and out of the furnace with help of a suspension transportation mechanism. At this time, it only needs to set accumulation type of flame radiation tubes on both sides of the glass sheet in the furnace vertically.

What is shown in the diagram is only one execution manner of this invention, and does not play any role of limiting the protective range of this invention. Accordingly, all suitable modifications and equivalents may be resorted to fall within the scope of the invention.

1. A glass sheet heating furnace includes a furnace body, a control device, and a glass sheet inlet and outlet in the furnace body a glass sheet transporting mechanism is set in the furnace body wherein numbers of heating zones are set inside the furnace body, at least one heat accumulation type flame radiation tube is set in each heating zone said heat accumulation type flame radiation tube is composed of a couple of main burner guns and a radiation tube connecting the two main burner guns said main burner gun has a heat accumulator inside it and uses diesel oil, or natural gas, or city gas or liquefied petroleum gas as fuel; matching with each heat accumulation type flame radiation tube, corresponding main fuel transporting pipe, main air supply pipe and main smoke venting pipe are set outside of the furnace body, control valves are set between each main burner gun and main fuel transporting pipe, said heat accumulation type flame radiation tube each is equipped with a two-position four-way valve, the air port of the two main burner guns in the heat accumulation type flame radiation tube is connected with the main air supply pipe and the main smoke venting pipe with help of the two-position four-way valve, and burning alternately, accumulating heat alternately and venting smoke alternately through switching over by the two-position four-way valve; said control device controls each accumulation type flame radiation tube, and each two-position four-way valve.

2. The glass sheet heating furnace according to claim 1, wherein the mentioned furnace body is horizontal type, which including the upper furnace body and lower furnace body, said lower furnace body is installed a roller-table type of glass sheet transportation mechanism.

3. The glass sheet heating furnace according to claim 1, wherein the mentioned control device is a PLC programmable controller.

4. The glass sheet heating furnace according to claim 3, wherein the mentioned radiation tube is in U shape or W shape or straight line shape, made of refractory steel.

5. The glass sheet heating furnace according to claim 4, wherein the mentioned heat accumulator is ball type porcelain heat accumulator or honeycomb ceramic heat accumulator.

6. The glass sheet heating furnace according to claim 5, wherein a proportion regulating valve for common use is set between the couple of main burner guns in the mentioned accumulation type flame radiation tube and the mentioned main fuel transporting pipe.

7. The glass sheet heating furnace according to claim 6, wherein an air-flow control valve is set between the mentioned two-position four-way valve and the main air supply pipe respectively, said air-flow control valve is interlinked with its corresponding proportion regulation valve.

8. The glass sheet heating furnace according to claim 7, wherein an ignition burner gun is set in each of the mentioned main burner gun and takes fuel gas as fuel, said ignition burner gun has its own air supply pipe and fuel transportation pipe independent of that the main burner gun, a control valve is set on the fuel transporting pipe.

9. The glass sheet heating furnace according to claim 8, wherein in each of the mentioned ignition burner gun are set an electronic ignition gun and an ion type (IS) or Ultraviolet type (UV) flame detecting sensor.

10. The glass sheet heating furnace according to claim 9, wherein in each heating zone of the mentioned furnace body, a thermocouple is set respectively to detect local temperature in each heating zone.

11. The glass sheet heating furnace according to claim 10, wherein CO₂ gas sensors are set in the mentioned furnace body.

12. The glass sheet heating furnace according to claim 11, wherein in the main smoke venting pipe is set a thermocouple, and a flow meter is set in the general fuel transporting pipe of each main burner gun.
